(19) United States
(12) Patent Application Publication
(10) Pub. No.: US 2026/0228424 A1
(43) Pub. Date: Aug. 6, 2026

(54) LARGE LANGUAGE MODEL ASSET GENERATION

(71) Applicant: Salesforce, Inc., San Francisco, CA (US)

(72) Inventors: Manjeet Singh, San Francisco, CA (US); Deepak Mukunthu, Sammamish, WA (US); Gary Brandeleer, San Francisco, CA (US); Hunter Reh, Seattle, WA (US); Sky Chen, Los Gatos, CA (US); Sitaram Asur, San Francisco, CA (US)

(21) Appl. No.: 19/043,085

(22) Filed: Jan. 31, 2025

(51) Int. Cl. G06F 40/20; G06F 16/383

(52) U.S. Cl. CPC G06F 40/20; G06F 16/383

(57) ABSTRACT

A system may receive a request for generation, by a large language model (LLM), of an LLM agent asset for a client. The system may provide, based on the request, a first plurality of inquiries associated with one or more parameters of the LLM agent asset. The system may receive a first plurality of responses. The system may determine, via the LLM and based on the first plurality of responses, whether a second plurality of inquiries is to be provided to the client. The system may provide the second plurality of inquiries to the client that may be based on the first plurality of responses and the determination. The system may receive a second plurality of responses in response. The system may generate the LLM agent asset based on the request, the first plurality of responses, and the second plurality of responses.

### FIELD OF TECHNOLOGY

The present disclosure relates generally to database systems and data processing, and more specifically to large language model asset generation.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, the cloud platform, a server, or other device may employ automated agents. However, such methods may be improved.

### BRIEF DESCRIPTION OF THE DRAWINGS

FIG. 1 illustrates an example of a LLM agent asset generation system that supports large language model asset generation in accordance with examples as disclosed herein.

FIG. 2 shows an example of a processing system that supports large language model asset generation in accordance with examples as disclosed herein.

FIG. 3 shows an example of a generation scheme that supports large language model asset generation in accordance with examples as disclosed herein.

FIG. 4 shows an example of a process flow that supports large language model asset generation in accordance with examples as disclosed herein.

FIG. 5 shows a block diagram of an apparatus that supports large language model asset generation in accordance with examples as disclosed herein.

FIG. 6 shows a block diagram of an LLM agent manager that supports large language model asset generation in accordance with examples as disclosed herein.

FIG. 7 shows a diagram of a system including a device that supports large language model asset generation in accordance with examples as disclosed herein.

FIG. 8 shows a flowchart illustrating methods that support large language model asset generation in accordance with examples as disclosed herein.

### DETAILED DESCRIPTION

End users are interested in quickly building and adopting agents, but the process of building, troubleshooting, and maintaining high quality agents is complex and such end users may not have the time or skill sets (e.g., for prompt engineering, for which no standard skill set has been defined) to use such agents effectively. Current agent-building processes involve extensive manual effort in planning, setup, testing, troubleshooting, and optimizing performance without clear indications where a user might start this process. This often leads to inefficiencies, errors, and suboptimal outcomes, resulting in delayed deployments and reduced business impact. Additionally, the lack of real-time feedback, best practice guidance, and automation tools for creating and refining agents creates bottlenecks in the development cycle. Users struggle to ensure that agents are fully tested, continuously optimized, and capable of delivering personalized, high-quality experiences. Without a streamlined and intelligent solution, businesses risk deploying underperforming agents, ultimately hindering their ability to scale their agents effectively.

The subject matter described herein includes a series of operational flows and prompt chains that allow a user to create detailed plans for what they need to create either agents, prompts for the agents, other information or elements to be used in connection with agents on a cloud platform. In some examples, such prompt chains may be grounded in information associated with the cloud platform (e.g., domain-specific information, user-defined or provided information, or other information that helps to ground one or more prompts of a prompt chain) to provide contextual information that improves the output of agent plans and prompt templates. For example, a user may be guided through the creation of agents and prompt templates (e.g., through questions generated by the system influenced by user context), and the user may provide natural language inputs to configure one or more parameters of the agents and prompt templates. The natural language inputs may be interpreted by the system (e.g., by a generative AI model or other model) and LLM agent assets (e.g., LLM agents or LLM prompts to be processed by LLM agents) may be provided in response that may be used in the generation of agents and prompt templates. In some examples, the user may interact with the system via an agent or via other user interfaces.

Aspects of the disclosure are initially described in the context of an environment supporting an on-demand database service. Aspects of the disclosure are then described with reference to a processing system, a generation scheme, and a process flow. Aspects of the disclosure are further illustrated by and described with reference to apparatus diagrams, system diagrams, and flowcharts that relate to large language model asset generation.

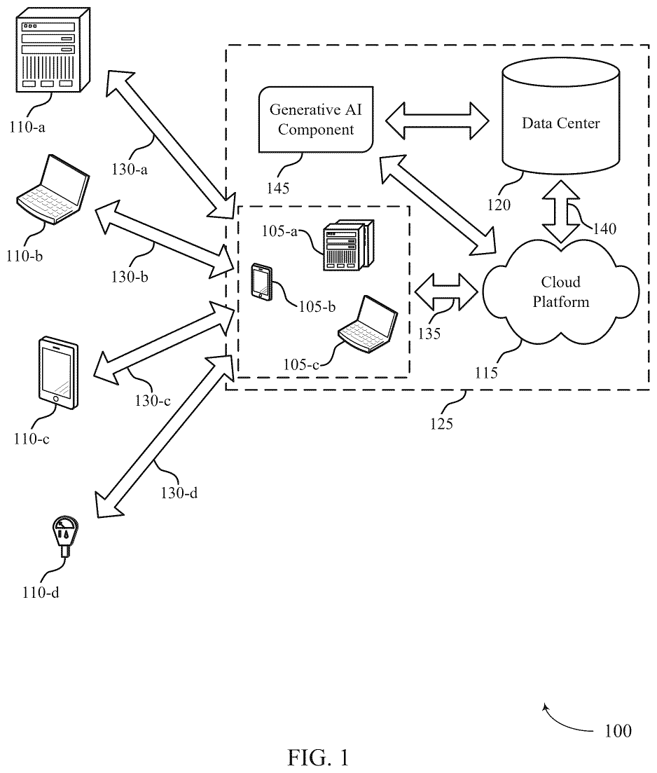

FIG. 1 illustrates an example of a system 100 for cloud computing that supports large language model asset generation in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

A cloud client 105 may transmit a request to generate an LLM agent asset (e.g., an LLM agent or a prompt to be processed by an LLM agent). The cloud client 105 may interact with the cloud platform 115 through text or voice input to provide responses to inquiries generated and transmitted to the cloud client 105. The cloud client 105 may respond to the inquiries with responses and the cloud platform 115 may generate the LLM agent asset based at least in part on the responses to the inquiries.

In some approaches, building, troubleshooting, and maintaining LLM agents is complex and may involve complex or even undefined skill sets for effective use. Further, current approaches to building LLM agents include large amounts of manual effort, such as for testing, planning, troubleshooting, and improving performance of such agents. As a result, LLM agent creation may be subject to inefficiencies, errors, and reduced performance, delaying deployment of the LLM agents. Further, other approaches suffer from a lack of feedback, best practice guidance or organizational standards enforcement for LLM agents, and rudimentary tools for LLM agent creation.

The subject matter described herein reduces or eliminates such issues with other approaches, as a user may create LLM agent assets (e.g., LLM agents, LLM agent prompts, other LLM agent assets, or any combination thereof) without extensive skill sets and through the use of natural language inputs. A system may be configured with an orientation prompt that instructs an LLM to ask questions of a client, determine whether sufficient information or context is found in the responses to the questions, and optionally engage in follow up or additional questioning to obtain more information about desired features of the LLM agent asset. The system may determine (e.g., through LLM interpretation and translation of the responses obtained from the client, contextual information associated with the client, such as metadata associated with a cloud platform, or other information) one or more topics, operations, metadata, contextual information, or other information that are to be included in the LLM agent asset. The LLM agent asset may then be generated based on the orientation prompt, the responses, the metadata, additional retrieved information, or any combination thereof. As the generation of the LLM agent asset is guided by the orientation prompt and interpretation of natural language input (and due to other techniques described herein), the generation process of the LLM agent is faster, less error prone, and provides superior performance as compared to other approaches.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

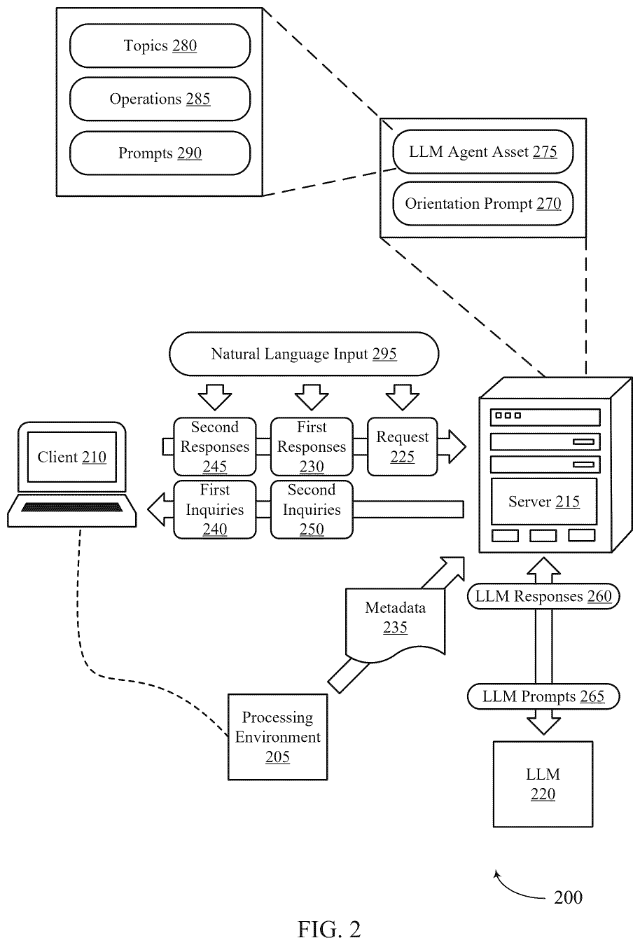

FIG. 2 shows an example of a processing system 200 that supports large language model asset generation in accordance with examples as disclosed herein. The processing system 200 may include a client 210, a server 215, and an LLM 220. The server 215 may represent a single server or processing entity, multiple servers or processing entities, a complete processing system, or any other entity capable of performing the operations described herein. The LLM 220 may be included as part of or otherwise associated with the server 215 or may operate as an entity distinct from (e.g., but still associated with) the server 215.

In some examples, the processing system 200 may be employed to produce the LLM agent asset 275. The LLM agent asset 275 may be an LLM agent. An LLM agent may include one or more prompts that may be provided to the LLM 220 or another LLM to perform one or more operations associated with an LLM agent.

In some examples, the client may transit a request 225 to the server 215. The request 225 may include a request to generate an LLM agent asset 275. Additionally, or alternatively, the request 225 may include information associated with the LLM agent asset 275. For example, the request 225 may include information such as a name for the LLM agent asset 275, an associated job title, a company website, an industry, a description of the LLM agent asset 275, other information about the LLM agent asset 275, contextual information associated with the 275 or the client 210, other information, or any combination thereof. In some examples, the request 225 may be expressed in natural language, such as text or voice (e.g., audio) information.

In some examples, the processing system 200 may provide the orientation prompt 270 to the LLM 220. The orientation prompt 270 may include instructions for the LLM 220 to analyze the request 225, generate one or more inquiries (e.g., the first inquiries 240, the second inquiries 250, one or more other inquiries, or any combination thereof), determine whether additional inquiries (e.g., the second inquiries 250) should be sent to the client 210 to request additional information for generation of the LLM agent asset 275. In some examples, the orientation prompt 270 may include one or more rules for generating the first inquiries 240, the second inquiries 250, one or more other inquiries, or any combination thereof based on the request 225 and one or more parameters (e.g., as set by administrators). For example, in some examples, the processing system 200 may be configured with a set of information that is to be retrieved from the client 210 to aid in creation of the LLM agent asset 275. If one or more items of the set of information are determined (e.g., by the LLM 220) to be missing, the processing system 200 may query or inquire (e.g., in the first inquiries 240, the second inquiries 250, one or more other inquiries, or any combination thereof) for the missing information.

In some examples, the processing system 200 may provide the first inquiries 240 to the client 210. The first inquiries 240 may include questions or requests for information that may be formulated based on the request 225. For example, the LLM 220 may analyze the request 225 and formulate one or more questions associated with information included in the request 225 and may do so in accordance with rules included in the orientation prompt 270. In some examples, the processing system 200 may retrieve additional information determined based on information included in the request 225 (e.g., context-specific information) to formulate the first inquiries 240.

In some examples, the processing system 200 may receive the first responses 230 to the first inquiries 240. The first responses 230 may be analyzed by the processing system 200 (e.g., by providing the first responses 230 to the LLM 220, such as in an LLM prompt 265 and further by receiving an LLM response 260 including one or more analysis results) and information determined to be relevant to the LLM agent asset 275 may be stored.

In some examples, the processing system 200 may determine (e.g., based on one or more instructions included in the orientation prompt 270, an analysis of the first inquiries 240, or both) whether the processing system 200 is to transmit the second inquiries 250 to the client 210. For example, the processing system 200 may determine whether one or more rules (e.g., included in the orientation prompt 270) have been satisfied. If the rules have not been satisfied, the processing system 200 may determine to transmit the second inquiries 250 to the client 210. If the rules have been satisfied, the processing system 200 may not transmit the second inquiries 250.

In the case in which the processing system 200 determines to transmit the second inquiries 250, the processing system 200 may transmit the second inquiries 250 to the client 210. In some examples, the second inquiries 250 may be generated based at least in part on the orientation prompt 270, the first responses 230, one or more rules for inquiry generation, contextual information associated with the LLM agent asset 275 or the client 210, or any combination thereof. In some examples, the processing system 200 may employ the LLM 220 to generate the second inquiries 250 (e.g., by transmitting the first responses 230 to the LLM 220 and requesting an analysis of the first responses 230, any other information described herein, or any combination thereof, to generate the second inquiries 250 to request information that may be missing or incomplete (e.g., if only the first responses 230 were used).

In some examples, the processing system 200 may receive the second responses 245 from the client 210 in response to the second inquiries 250. In some examples, the second responses 245 may include additional information (e.g., different than information received in the first responses 230) that may provide additional context, information, or instructions for generation of the LLM agent asset 275.

In some examples, the processing system 200 may retrieve metadata 235 (or other data) from the processing environment 205 (or another source). The metadata 235 may be associated with the use of the processing environment 205 by the client 210, other associated clients, one or more users, groups, or organizations, or any combination thereof. The processing system 200 may perform any of the operations described herein based at least in part on the metadata 235.

In some examples, the processing system 200 may generate the LLM agent asset 275 based on the first responses 230, the second responses 245, the orientation prompt 270, the metadata 235, any other information described herein, or any combination thereof. For example, the processing system 200 may determine one or more topics 280, operations 285, prompts 290, other information, or any combination thereof that are to be included in or indicated in the LLM agent asset 275. The topics 280 may be topics for which the LLM agent asset 275 to operate or be utilized. The topics 280 may be domain-specific or context-specific, or may be applicable across various domains or contexts. In some examples, the LLM agent asset 275 may include one or more operations 285 that are available to the LLM agent asset 275 or the processing system 200. In some examples, the operations 285 may be associated with one or more topics 280 included or indicated in the LLM agent asset 275. In some examples, the operations 285 may be operations that may implement one or more operations indicated in the request 225, the first responses 230, the second responses 245, any other information described herein, or any combination thereof. The prompts 290 may be prompts that may be provided to the LLM 220 in associated with utilizing the LLM agent asset 275. For example, the prompts 290 may include instructions that may provide instructions or information to the LLM 220 in associated with the LLM agent asset 275 being utilized after generation of the LLM agent asset 275.

Any of the topics 280, the operations 285, the prompts 290, other information included or indicated in the LLM agent asset 275, or any combination thereof, may be determined, selected, or identified based at least in part on the first responses 230, the second responses 245, the request 225, the orientation prompt 270, any other information described herein, or any combination thereof. For example, similarity measures may be used to determine which topics 280, operations 285, prompts 290, or other information is most similar to information indicated in the request 225, the first responses 230, the second responses 245 and should therefore be included in the LLM agent asset 275.

In some examples, the request 225, the first responses 230, the second responses 245, any other elements described herein, or any combination thereof, may include natural language input 295. The natural language input 295 may include or indicate text data or audio data (e.g., voice data).

Any of the operations described herein may be performed in association with the LLM 220. For example, any of the operations described may be indicated in one or more LLM prompts 265. The LLM prompts 265 may be processed by the LLM 220 and the LLM 220 may generate and transmit one or more LLM responses 260 that may include or indicate a result of the processing, analysis, determination, or any other operation performed by the LLM 220 in response to the LLM prompts 265.

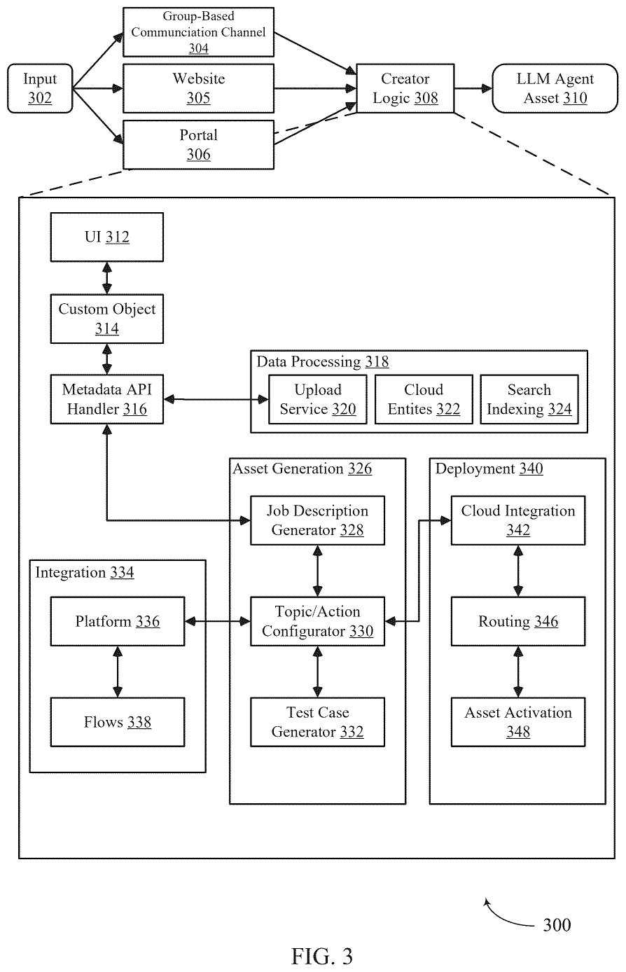

FIG. 3 shows an example of a generation scheme 300 that supports large language model asset generation in accordance with examples as disclosed herein. Though some connections are depicted, others may not be shown for clarity. However, it is to be understood that any entity or operation may be connected or related to any other entity or operation depicted.

In some examples, the input 302 may be input received from a user or client. The input 302 may include text or audio (e.g., voice) data that may indicate a request to generate the LLM agent asset 310 (e.g., an LLM agent or an LLM agent prompt). The input 302 may include additional information that may be used for generation of the LLM agent asset 310. In some examples, the input 302 may correspond with the request 225, the first responses 230, the second responses 245, any other information received at the server 215 from the client 210, or any combination thereof.

In some examples, the generation scheme 300 may include various interaction channels through which a client or user may interact with a system implementing the generation scheme 300. For example, such interaction channels may include a group-based communication channel 304 (e.g., associated with a group-based communications platform or service), a website 305, a portal 306, one or more other interfaces or interaction methods, or any combination thereof.

In some examples, the creator logic 308 may represent one or more operations performed by a system to implement one or more portions of the generation scheme 300. One or more portions of the creator logic 308 may be performed to generate the LLM agent asset 310.

In some examples, a client or user may interact with a system implementing the generation scheme 300 through a user interface (UI), such as the UI 312. The UI 312 may receive or obtain inputs from the client or user and may provide outputs to the client or user. In some examples, the UI 312 may be associated with any interaction channels, including the group-based communication channel 304, the website 305, the portal 306, any other interaction channels, or any combination thereof.

In some examples, the custom object 314 may be used to manage or associate one or more operations or information of the generation scheme 300. For example, information received from the client in response to inquiries (or any other information, such as metadata associated with the) may be stored in or associated with the custom object 314. Further, any of the operations described herein may be performed in association with the custom object 314.

In some examples, the metadata API handler 316 may provide an interface with an application programming interface (API) for retrieving metadata associated with generation of the LLM agent asset 310. For example, the metadata API handler 316 may transmit requests to retrieve the metadata from a processing environment or other data source. Further, the metadata API handler 316 may receive the metadata from the processing environment or other data source.

In some examples, the data processing 318 may include or be associated with one or more operations or entities for processing data to support generation of the LLM agent asset 310. For example, the upload service 320 may provide for communication of the metadata or any other data that may be requested, retrieved, or processed to support generation of the LLM agent asset 310.

In some examples, the cloud entities 322 may be one or more processing or storage entities that may store or process data to support generation of the LLM agent asset 310, such as the metadata or any other information described herein.

In some examples, the search indexing 324 may involve indexing of any information associated with the data processing 318. For example, the search indexing 324 may perform one or more search or indexing operations of the metadata or any other data described herein to support generation of the LLM agent asset 310.

In some examples, the asset generation 326 may include or be associated with one or more entities or operations associated with generation of the LLM agent asset 310. For example, the job description generator 328 may generate (e.g., through the use of an LLM) one or more job descriptions. Such job descriptions may described one or more operations, analyses, determinations, or other operations that are to be performed by an LLM to support generation of the LLM agent asset 310.

In some examples, the topic/action configurator 330 may configure one or more topics or actions (e.g., that are to be included or indicated in the LLM agent asset 310), such as the topics 280, the operations 285, the prompts 290, one or more other operations or information associated with the LLM agent asset 275 or the LLM agent asset 310, or any combination thereof. For example, the topic/action configurator 330 may select or indicate the topics, actions, or other information that are to be included or indicated in the LLM agent asset 310.

In some examples, the test case generator 332 may be used generate one or more test cases (e.g., preliminary versions of the LLM agent asset 310) to aid in determinations (e.g., through the use of an LLM) of whether additional inquiries are to be sent to the client or user (e.g., as described with reference to FIG. 2), whether one or more rules or conditions are met for generation of the LLM agent asset 310, or to support any other operations described herein. For example, a system may analyze one or more test cases (e.g., preliminary versions of the LLM agent asset 310).

In some examples, the integration 334 may include or be associated with one or more operations or entities that involve integration or deployment of the LLM agent asset 310 for use by clients or users. For example, the platform 336 may be a processing platform into which the LLM agent asset 310 may be integrated. The platform 336 may house or permit interaction with the LLM agent asset 310 (e.g., provide a user interface or other supporting operations) to support the user of the LLM agent asset 310 after generation. Additionally, or alternatively, the flows 338 may be processing flows supported by a cloud platform that may permit interaction or integration of the LLM agent asset 310 into processing flows. For example, such flows 338 may define or indicate patterns or “routes” of processing operations and information, and one or more operations therein may be performed by or associated with the LLM agent asset 310.

In some examples, the deployment 340 may include or indicate one or more entities or operations associated with deploying the LLM agent asset 310 for use by clients or users after generation. For example, the deployment 340 may include or indicate the cloud integration 342, which may integrate the LLM agent asset 310 or one or more elements thereof (e.g., topics or actions) with operations or elements of a cloud platform. For example, the cloud integration 342 may provide for access to one or more topics, actions (e.g., operations) or information available at a cloud platform that may be utilized in connection with deployment of the LLM agent asset 310. In some examples, the routing 346 may indicate or include operations for routing information, commands, or operations across various elements of a processing platform or environment, cloud platform, or other system or environment in which the LLM agent asset 310 may be deployed. For example, the routing 346 may provide for routing of communications or information associated with the LLM agent asset 310 that may be performed or utilized in associated with the LLM agent asset 310.

In some examples, the asset activation 348 may provide for activation or indication of the LLM agent asset 310 after generation. For example, the asset activation 348 may activate the LLM agent asset 310 (e.g., in cases in which the LLM agent asset 310 is an LLM agent) or may activate an LLM agent associated with the LLM agent asset 310 (e.g., incases in which the LLM agent asset 310 is a prompt to be used with an LLM agent.

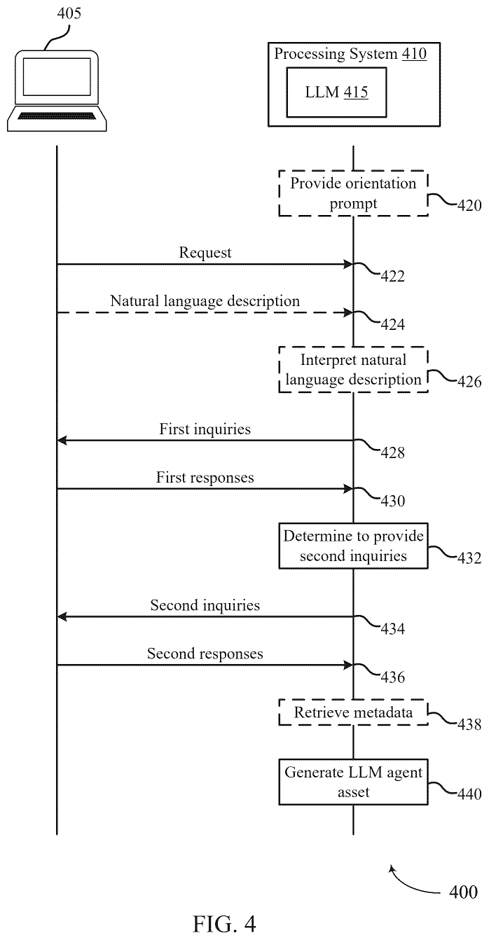

FIG. 4 shows an example of a process flow 400 that supports large language model asset generation in accordance with examples as disclosed herein. The process flow 400 may implement various aspects of the present disclosure described herein. The elements described in the process flow 400 (e.g., processing system 410, client 405, and LLM 415) may be examples of similarly named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the processing system 410 may provide an orientation prompt to the LLM 415, the orientation prompt that may include instructions for the LLM 415 to provide the first plurality of inquiries, determine whether the second plurality of inquiries is to be provided to the client 405, provide the second plurality of inquiries to the client 405, and generate the LLM agent asset.

At 422, the processing system 410 may receive a request for generation, by an LLM 415, of an LLM agent asset for a client 405. In some examples, request comprise an indication of a purpose of the LLM agent asset and an indication of data to be associated with the LLM agent asset. In some examples, the LLM agent asset may include an LLM 415, an LLM 415 prompt, or an LLM 415 prompt template. In some examples, the processing system 410 may receive the request via a group-based communication service, a web interface, a web portal, or any combination thereof. In some examples, the request may include text input, audio input, or any combination thereof.

At 424, the processing system 410 may receive a natural language description of one or more characteristics of the LLM agent asset.

At 426, the processing system 410 may interpret, with the LLM 415, the natural language description to produce an indication of one or more LLM agent asset parameters corresponding with the one or more characteristics of the LLM agent asset.

At 428, the processing system 410 may providing, based at least in part on the request, a first plurality of inquiries associated with one or more parameters of the LLM agent asset. In some examples, providing the first plurality of inquiries is based on the one or more LLM agent asset parameters.

At 430, the processing system 410 may receive a first plurality of responses to the first plurality of inquiries. In some examples, the processing system 410 may receive the first plurality of inquiries via a group-based communication service, a web interface, a web portal, or any combination thereof. In some examples, the first plurality of responses may include text input, audio input, or any combination thereof.

At 432, the processing system 410 may determine, via the LLM 415 and based on the first plurality of responses, whether a second plurality of inquiries associated with one or more parameters of the LLM agent asset is to be provided to the client 405. In some examples, to determine whether to provide the second plurality of inquiries, the processing system 410 may provide a prompt to the LLM 415, that may include a first instruction to analyze the first plurality of responses and the request to determine whether the LLM agent asset can be generated with information included in the first plurality of responses and the request and receive an analysis response indicating that the second plurality of inquiries is to be provided to the client 405.

At 434, the processing system 410 may provide the second plurality of inquiries to the client 405, the second plurality of inquiries based on the first plurality of responses and the determination. In some examples, providing the second plurality of inquiries is based on the one or more LLM agent asset parameters.

At 436, the processing system 410 may receive a second plurality of responses in response to the second plurality of inquiries. In some examples, the processing system 410 may receive the second plurality of inquiries via a group-based communication service, a web interface, a web portal, or any combination thereof. In some examples, the second plurality of responses may include text input, audio input, or any combination thereof.

At 438, the processing system 410 may receive an indication of metadata associated with a processing environment associated with the client 405.

At 440, the processing system 410 may generate the LLM agent asset based on the request, the first plurality of responses, and the second plurality of responses. In some examples, to generate the LLM agent asset, the processing system 410 may select, based on the request, the first plurality of responses, the second plurality of responses, or any combination thereof, one or more topics to be associated with the LLM agent asset, each topic being associated with a topic name, a classification description, a plurality of permitted operations that are associated with a cloud platform associated with the client 405, a plurality of prompt instructions, or any combination thereof. In some examples, to generate the LLM agent asset, the processing system 410 may associate the selected one or more topics with the LLM agent asset. In some examples, to generate the LLM agent asset, the processing system 410 may select, based on the request, the first plurality of responses, the second plurality of responses, or any combination thereof, the plurality of permitted operations from a plurality of operations available to the LLM agent asset. In some examples, to generate the LLM agent asset, the processing system 410 may associate the selected one or more operations with the LLM agent asset. In some examples, to generate the LLM agent asset, the processing system 410 may embed information selected from at least the first plurality of responses, the second plurality of responses, or both, into one or more prompts associated with the LLM agent asset. In some examples, generating the LLM agent asset are based on the one or more LLM agent asset parameters. In some examples, generating the LLM agent asset is based on processing the metadata with the LLM 415 to produce one or more characteristics of the LLM agent asset.

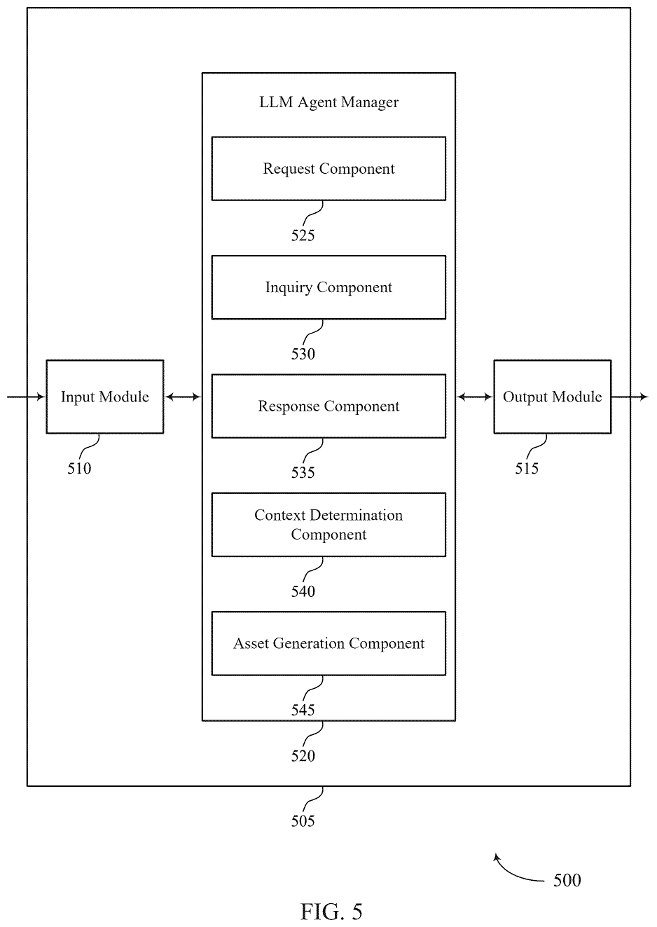

FIG. 5 shows a block diagram 500 of a device 505 that supports large language model asset generation in accordance with examples as disclosed herein. The device 505 may include an input module 510, an output module 515, and an LLM agent manager 520. The device 505, or one or more components of the device 505 (e.g., the input module 510, the output module 515, the LLM agent manager 520), may include at least one processor, which may be coupled with at least one memory, to support the described techniques. Each of these components may be in communication with one another (e.g., via one or more buses).

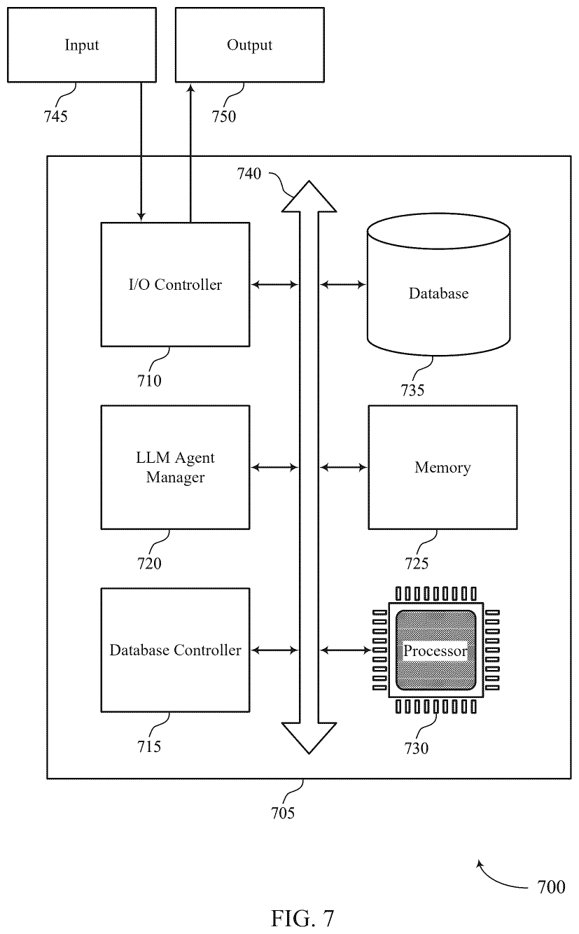

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the LLM agent manager 520 to support large language model asset generation. In some cases, the input module 510 may be a component of an input/output (I/O) controller 710 as described with reference to FIG. 7.

The output module 515 may manage output signals for the device 505. For example, the output module 515 may receive signals from other components of the device 505, such as the LLM agent manager 520, and may transmit these signals to other components or devices. In some examples, the output module 515 may transmit output signals for display in a user interface, for storage in a database or data store, for further processing at a server or server cluster, or for any other processes at any quantity of devices or systems. In some cases, the output module 515 may be a component of an I/O controller 710 as described with reference to FIG. 7.

For example, the LLM agent manager 520 may include a request component 525, an inquiry component 530, a response component 535, a context determination component 540, an asset generation component 545, or any combination thereof. In some examples, the LLM agent manager 520, or various components thereof, may be configured to perform various operations (e.g., receiving, monitoring, transmitting) using or otherwise in cooperation with the input module 510, the output module 515, or both. For example, the LLM agent manager 520 may receive information from the input module 510, send information to the output module 515, or be integrated in combination with the input module 510, the output module 515, or both to receive information, transmit information, or perform various other operations as described herein.

The LLM agent manager 520 may support large language model (LLM) agent asset generation in accordance with examples as disclosed herein. The request component 525 may be configured to support receiving a request for generation, by an LLM, of an LLM agent asset for a client. The inquiry component 530 may be configured to support providing, based on the request, a first plurality of inquiries associated with one or more parameters of the LLM agent asset. The response component 535 may be configured to support receiving a first set of multiple responses to the first plurality of inquiries. The context determination component 540 may be configured to support determining, via the LLM and based on the first set of multiple responses, whether a second plurality of inquiries associated with one or more parameters of the LLM agent asset is to be provided to the client. The inquiry component 530 may be configured to support providing the second plurality of inquiries to the client, the second plurality of inquiries based on the first set of multiple responses and the determination. The response component 535 may be configured to support receiving a second set of multiple responses in response to the second plurality of inquiries. The asset generation component 545 may be configured to support generating the LLM agent asset based on the request, the first set of multiple responses, and the second set of multiple responses.

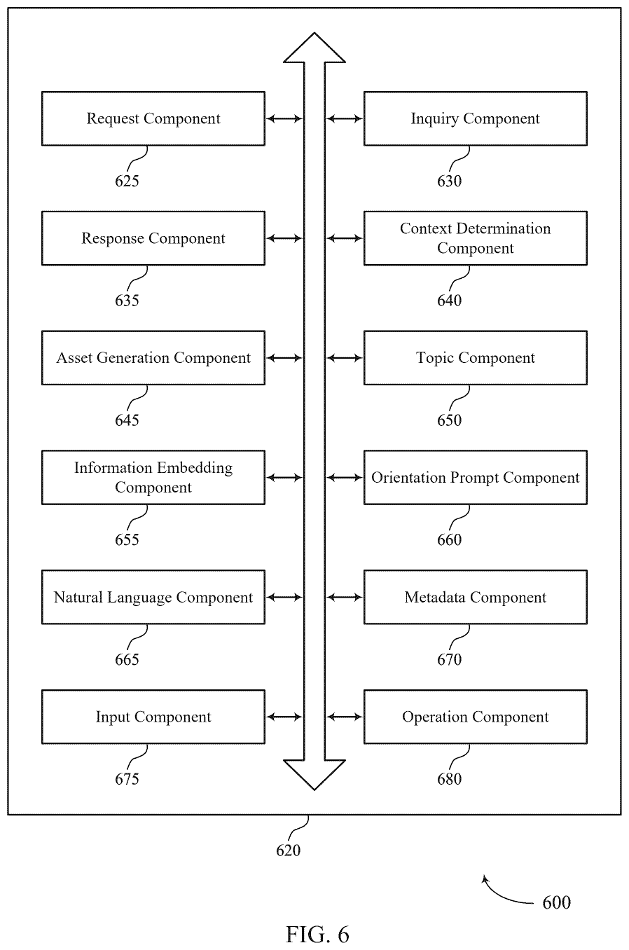

FIG. 6 shows a block diagram 600 of an LLM agent manager 620 that supports large language model asset generation in accordance with examples as disclosed herein. The LLM agent manager 620 may be an example of aspects of an LLM agent manager or an LLM agent manager 520, or both, as described herein. The LLM agent manager 620, or various components thereof, may be an example of means for performing various aspects of large language model asset generation as described herein. For example, the LLM agent manager 620 may include a request component 625, an inquiry component 630, a response component 635, a context determination component 640, an asset generation component 645, a topic component 650, an information embedding component 655, an orientation prompt component 660, a natural language component 665, a metadata component 670, an input component 675, an operation component 680, or any combination thereof. Each of these components, or components of subcomponents thereof (e.g., one or more processors, one or more memories), may communicate, directly or indirectly, with one another (e.g., via one or more buses).

The LLM agent manager 620 may support large language model (LLM) agent asset generation in accordance with examples as disclosed herein. The request component 625 may be configured to support receiving a request for generation, by an LLM, of an LLM agent asset for a client. The inquiry component 630 may be configured to support providing, based on the request, a first plurality of inquiries associated with one or more parameters of the LLM agent asset. The response component 635 may be configured to support receiving a first set of multiple responses to the first plurality of inquiries. The context determination component 640 may be configured to support determining, via the LLM and based on the first set of multiple responses, whether a second plurality of inquiries associated with one or more parameters of the LLM agent asset is to be provided to the client. In some examples, the inquiry component 630 may be configured to support providing the second plurality of inquiries to the client, the second plurality of inquiries based on the first set of multiple responses and the determination. In some examples, the response component 635 may be configured to support receiving a second set of multiple responses in response to the second plurality of inquiries. The asset generation component 645 may be configured to support generating the LLM agent asset based on the request, the first set of multiple responses, and the second set of multiple responses.

In some examples, to support generating the LLM agent asset, the topic component 650 may be configured to support selecting, based on the request, the first set of multiple responses, the second set of multiple responses, or any combination thereof, one or more topics to be associated with the LLM agent asset, each topic being associated with a topic name, a classification description, a set of multiple permitted operations that are associated with a cloud platform associated with the client, a set of multiple prompt instructions, or any combination thereof. In some examples, to support generating the LLM agent asset, the topic component 650 may be configured to support associating the selected one or more topics with the LLM agent asset.

In some examples, to support generating the LLM agent asset, the operation component 680 may be configured to support selecting, based on the request, the first set of multiple responses, the second set of multiple responses, or any combination thereof, the set of multiple permitted operations from a set of multiple operations available to the LLM agent asset. In some examples, to support generating the LLM agent asset, the operation component 680 may be configured to support associating the selected one or more operations with the LLM agent asset.

In some examples, generating the LLM agent asset includes embedding information selected from at least the first set of multiple responses, the second set of multiple responses, or both, into one or more prompts associated with the LLM agent asset.

In some examples, to support determining whether second plurality of inquiries is to be provided to the client, the context determination component 640 may be configured to support providing a prompt to the LLM, including a first instruction to analyze the first set of multiple responses and the request to determine whether the LLM agent asset can be generated with information included in the first set of multiple responses and the request. In some examples, to support determining whether second plurality of inquiries is to be provided to the client, the context determination component 640 may be configured to support receiving an analysis response indicating that the second plurality of inquiries is to be provided to the client.

In some examples, the orientation prompt component 660 may be configured to support providing an orientation prompt to the LLM, the orientation prompt including instructions for the LLM to provide the first plurality of inquiries, determine whether the second plurality of inquiries is to be provided to the client, provide the second plurality of inquiries to the client, and generate the LLM agent asset.

In some examples, the natural language component 665 may be configured to support receiving a natural language description of one or more characteristics of the LLM agent asset. In some examples, the natural language component 665 may be configured to support interpreting, with the LLM, the natural language description to produce an indication of one or more LLM agent asset parameters corresponding with the one or more characteristics of the LLM agent asset. In some examples, the asset generation component 645 may be configured to support where providing the first plurality of inquiries, providing the second plurality of inquiries, and generating the LLM agent asset are based on the one or more LLM agent asset parameters.

In some examples, the request include an indication of a purpose of the LLM agent asset and an indication of data to be associated with the LLM agent asset.

In some examples, the metadata component 670 may be configured to support receiving an indication of metadata associated with a processing environment associated with the client. In some examples, the asset generation component 645 may be configured to support where generating the LLM agent asset is based on processing the metadata with the LLM to produce one or more characteristics of the LLM agent asset.

In some examples, the LLM agent asset includes a second LLM, an LLM prompt, or an LLM prompt template.

In some examples, the input component 675 may be configured to support receiving the request, the first plurality of inquiries, the second plurality of inquiries, or any combination thereof, via a group-based communication service, a web interface, a web portal, or any combination thereof.

In some examples, the request, the first plurality of inquiries, the second plurality of inquiries, or any combination thereof, include text input, audio input, or any combination thereof.

FIG. 7 shows a diagram of a system 700 including a device 705 that supports large language model asset generation in accordance with examples as disclosed herein. The device 705 may be an example of or include components of a device 505 as described herein. The device 705 may include components for bi-directional data communications including components for transmitting and receiving communications, such as an LLM agent manager 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting large language model asset generation). The processor 730 may be an example of a single processor or multiple processors. For example, the device 705 may include one or more processors 730.

The LLM agent manager 720 may support large language model (LLM) agent asset generation in accordance with examples as disclosed herein. For example, the LLM agent manager 720 may be configured to support receiving a request for generation, by an LLM, of an LLM agent asset for a client. The LLM agent manager 720 may be configured to support providing, based at least in part on the request, a first plurality of inquiries associated with one or more parameters of the LLM agent asset. The LLM agent manager 720 may be configured to support receiving a first set of multiple responses to the first plurality of inquiries. The LLM agent manager 720 may be configured to support determining, via the LLM and based on the first set of multiple responses, whether a second plurality of inquiries associated with one or more parameters of the LLM agent asset is to be provided to the client. The LLM agent manager 720 may be configured to support providing the second plurality of inquiries to the client, the second plurality of inquiries based on the first set of multiple responses and the determination. The LLM agent manager 720 may be configured to support receiving a second set of multiple responses in response to the second plurality of inquiries. The LLM agent manager 720 may be configured to support generating the LLM agent asset based on the request, the first set of multiple responses, and the second set of multiple responses.

By including or configuring the LLM agent manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

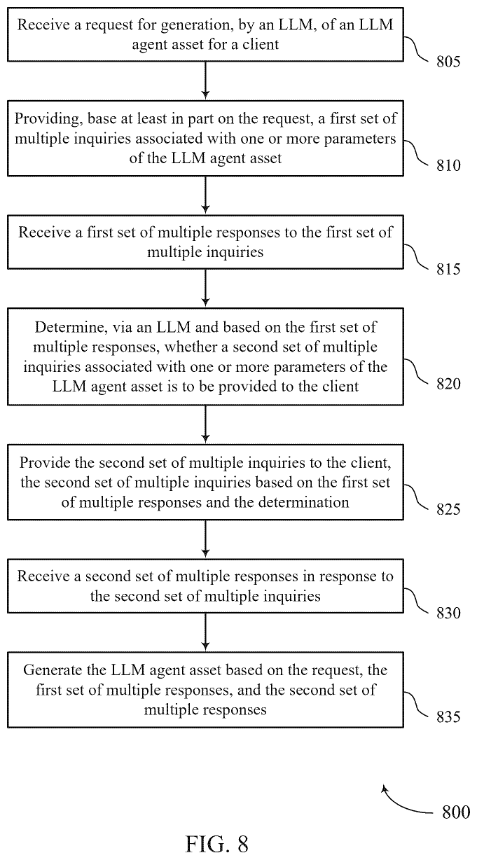

FIG. 8 shows a flowchart illustrating a method 800 that supports large language model asset generation in accordance with examples as disclosed herein. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 805, the method may include receiving a request for generation, by an LLM, of an LLM agent asset for a client. The operations of 805 may be performed in accordance with examples as disclosed herein. In some examples, aspects of the operations of 805 may be performed by a request component 625 as described with reference to FIG. 6.

At 810, the method may include providing, based on the request, a first plurality of inquiries associated with one or more parameters of the LLM agent asset. The operations of 810 may be performed in accordance with examples as disclosed herein. In some examples, aspects of the operations of 810 may be performed by an inquiry component 630 as described with reference to FIG. 6.

At 815, the method may include receiving a first set of multiple responses to the first plurality of inquiries. The operations of 815 may be performed in accordance with examples as disclosed herein. In some examples, aspects of the operations of 815 may be performed by a response component 635 as described with reference to FIG. 6.

At 820, the method may include determining, via the LLM and based on the first set of multiple responses, whether a second plurality of inquiries associated with one or more parameters of the LLM agent asset is to be provided to the client. The operations of 820 may be performed in accordance with examples as disclosed herein. In some examples, aspects of the operations of 820 may be performed by a context determination component 640 as described with reference to FIG. 6.

At 825, the method may include providing the second plurality of inquiries to the client, the second plurality of inquiries based on the first set of multiple responses and the determination. The operations of 825 may be performed in accordance with examples as disclosed herein. In some examples, aspects of the operations of 825 may be performed by an inquiry component 630 as described with reference to FIG. 6.

At 830, the method may include receiving a second set of multiple responses in response to the second plurality of inquiries. The operations of 830 may be performed in accordance with examples as disclosed herein. In some examples, aspects of the operations of 830 may be performed by a response component 635 as described with reference to FIG. 6.

At 835, the method may include generating the LLM agent asset based on the request, the first set of multiple responses, and the second set of multiple responses. The operations of 835 may be performed in accordance with examples as disclosed herein. In some examples, aspects of the operations of 835 may be performed by an asset generation component 645 as described with reference to FIG. 6.

A method for large language model (LLM) agent asset generation by an apparatus is described. The method may include receiving a request for generation, by an LLM, of an LLM agent asset for a client, providing, based on the request, a first plurality of inquiries associated with one or more parameters of the LLM agent asset, receiving a first set of multiple responses to the first plurality of inquiries, determining, via the LLM and based on the first set of multiple responses, whether a second plurality of inquiries associated with one or more parameters of the LLM agent asset is to be provided to the client, providing the second plurality of inquiries to the client, the second plurality of inquiries based on the first set of multiple responses and the determination, receiving a second set of multiple responses in response to the second plurality of inquiries, and generating the LLM agent asset based on the request, the first set of multiple responses, and the second set of multiple responses.

An apparatus for large language model (LLM) agent asset generation is described. The apparatus may include one or more memories storing processor executable code, and one or more processors coupled with the one or more memories. The one or more processors may individually or collectively be operable to execute the code to cause the apparatus to receive a request for generation, by an LLM, of an LLM agent asset for a client, providing, based at least in part on the request, a first plurality of inquiries associated with one or more parameters of the LLM agent asset, receive a first set of multiple responses to the first plurality of inquiries, determine, via the LLM and based on the first set of multiple responses, whether a second plurality of inquiries associated with one or more parameters of the LLM agent asset is to be provided to the client, provide the second plurality of inquiries to the client, the second plurality of inquiries based on the first set of multiple responses and the determination, receive a second set of multiple responses in response to the second plurality of inquiries, and generate the LLM agent asset based on the request, the first set of multiple responses, and the second set of multiple responses.

Another apparatus for large language model (LLM) agent asset generation is described. The apparatus may include means for receiving a request for generation, by an LLM, of an LLM agent asset for a client, means for providing, based on the request, a first plurality of inquiries associated with one or more parameters of the LLM agent asset, means for receiving a first set of multiple responses to the first plurality of inquiries, means for determining, via the LLM and based on the first set of multiple responses, whether a second plurality of inquiries associated with one or more parameters of the LLM agent asset is to be provided to the client, means for providing the second plurality of inquiries to the client, the second plurality of inquiries based on the first set of multiple responses and the determination, means for receiving a second set of multiple responses in response to the second plurality of inquiries, and means for generating the LLM agent asset based on the request, the first set of multiple responses, and the second set of multiple responses.

A non-transitory computer-readable medium storing code for large language model (LLM) agent asset generation is described. The code may include instructions executable by one or more processors to receive a request for generation, by an LLM, of an LLM agent asset for a client, providing, based at least in part on the request, a first plurality of inquiries associated with one or more parameters of the LLM agent asset, receive a first set of multiple responses to the first plurality of inquiries, determine, via the LLM and based on the first set of multiple responses, whether a second plurality of inquiries associated with one or more parameters of the LLM agent asset is to be provided to the client, provide the second plurality of inquiries to the client, the second plurality of inquiries based on the first set of multiple responses and the determination, receive a second set of multiple responses in response to the second plurality of inquiries, and generate the LLM agent asset based on the request, the first set of multiple responses, and the second set of multiple responses.

In some examples of the method, apparatus, and non-transitory computer-readable medium described herein, generating the LLM agent asset may include operations, features, means, or instructions for selecting, based on the request, the first set of multiple responses, the second set of multiple responses, or any combination thereof, one or more topics to be associated with the LLM agent asset, each topic being associated with a topic name, a classification description, a set of multiple permitted operations that may be associated with a cloud platform associated with the client, a set of multiple prompt instructions, or any combination thereof and associating the selected one or more topics with the LLM agent asset.

In some examples of the method, apparatus, and non-transitory computer-readable medium described herein, generating the LLM agent asset may include operations, features, means, or instructions for selecting, based on the request, the first set of multiple responses, the second set of multiple responses, or any combination thereof, the set of multiple permitted operations from a set of multiple operations available to the LLM agent asset and associating the selected one or more operations with the LLM agent asset.

Some examples of the method, apparatus, and non-transitory computer-readable medium described herein may further include operations, features, means, or instructions for generating the LLM agent asset includes embedding information selected from at least the first set of multiple responses, the second set of multiple responses, or both, into one or more prompts associated with the LLM agent asset.

In some examples of the method, apparatus, and non-transitory computer-readable medium described herein, determining whether second plurality of inquiries is to be provided to the client may include operations, features, means, or instructions for providing a prompt to the LLM, including a first instruction to analyze the first set of multiple responses and the request to determine whether the LLM agent asset can be generated with information included in the first set of multiple responses and the request and receiving an analysis response indicating that the second plurality of inquiries is to be provided to the client.

Some examples of the method, apparatus, and non-transitory computer-readable medium described herein may further include operations, features, means, or instructions for providing an orientation prompt to the LLM, the orientation prompt including instructions for the LLM to provide the first plurality of inquiries, determine whether the second plurality of inquiries is to be provided to the client, provide the second plurality of inquiries to the client, and generate the LLM agent asset.

Some examples of the method, apparatus, and non-transitory computer-readable medium described herein may further include operations, features, means, or instructions for receiving a natural language description of one or more characteristics of the LLM agent asset, interpreting, with the LLM, the natural language description to produce an indication of one or more LLM agent asset parameters corresponding with the one or more characteristics of the LLM agent asset, and where providing the first plurality of inquiries, providing the second plurality of inquiries, and generating the LLM agent asset may be based on the one or more LLM agent asset parameters.

In some examples of the method, apparatus, and non-transitory computer-readable medium described herein, the request include an indication of a purpose of the LLM agent asset and an indication of data to be associated with the LLM agent asset.

Some examples of the method, apparatus, and non-transitory computer-readable medium described herein may further include operations, features, means, or instructions for receiving an indication of metadata associated with a processing environment associated with the client and where generating the LLM agent asset may be based on processing the metadata with the LLM to produce one or more characteristics of the LLM agent asset.

In some examples of the method, apparatus, and non-transitory computer-readable medium described herein, the LLM agent asset includes a second LLM, an LLM prompt, or an LLM prompt template.

Some examples of the method, apparatus, and non-transitory computer-readable medium described herein may further include operations, features, means, or instructions for receiving the request, the first plurality of inquiries, the second plurality of inquiries, or any combination thereof, via a group-based communication service, a web interface, a web portal, or any combination thereof.

In some examples of the method, apparatus, and non-transitory computer-readable medium described herein, the request, the first plurality of inquiries, the second plurality of inquiries, or any combination thereof, include text input, audio input, or any combination thereof.

The following provides an overview of aspects of the present disclosure:

Aspect 1: A method for large language model (LLM) agent asset generation, comprising: receiving a request for generation, by an LLM, of an LLM agent asset for a client; providing, based at least in part on the request, a first plurality of inquiries associated with one or more parameters of the LLM agent asset; receiving a first plurality of responses to the first plurality of inquiries; determining, via the LLM and based at least in part on the first plurality of responses, whether a second plurality of inquiries associated with one or more parameters of the LLM agent asset is to be provided to the client; providing the second plurality of inquiries to the client, the second plurality of inquiries based at least in part on the first plurality of responses and the determination; receiving a second plurality of responses in response to the second plurality of inquiries; and generating the LLM agent asset based at least in part on the request, the first plurality of responses, and the second plurality of responses.

Aspect 2: The method of aspect 1, wherein generating the LLM agent asset comprises: selecting, based at least in part on the request, the first plurality of responses, the second plurality of responses, or any combination thereof, one or more topics to be associated with the LLM agent asset, each topic being associated with a topic name, a classification description, a plurality of permitted operations that are associated with a cloud platform associated with the client, a plurality of prompt instructions, or any combination thereof; and associating the selected one or more topics with the LLM agent asset.

Aspect 3: The method of aspect 2, wherein generating the LLM agent asset comprises: selecting, based at least in part on the request, the first plurality of responses, the second plurality of responses, or any combination thereof, the plurality of permitted operations from a plurality of operations available to the LLM agent asset; and associating the selected one or more operations with the LLM agent asset.

Aspect 4: The method of any of aspects 1 through 3, wherein generating the LLM agent asset comprises embedding information selected from at least the first plurality of responses, the second plurality of responses, or both, into one or more prompts associated with the LLM agent asset.

Aspect 5: The method of any of aspects 1 through 4, wherein determining whether second plurality of inquiries is to be provided to the client comprises: providing a prompt to the LLM, comprising a first instruction to analyze the first plurality of responses and the request to determine whether the LLM agent asset can be generated with information included in the first plurality of responses and the request; and receiving an analysis response indicating that the second plurality of inquiries is to be provided to the client.

Aspect 6: The method of any of aspects 1 through 5, further comprising: providing an orientation prompt to the LLM, the orientation prompt comprising instructions for the LLM to provide the first plurality of inquiries, determine whether the second plurality of inquiries is to be provided to the client, provide the second plurality of inquiries to the client, and generate the LLM agent asset.

Aspect 7: The method of any of aspects 1 through 6, further comprising: receiving a natural language description of one or more characteristics of the LLM agent asset; and interpreting, with the LLM, the natural language description to produce an indication of one or more LLM agent asset parameters corresponding with the one or more characteristics of the LLM agent asset; wherein providing the first plurality of inquiries, providing the second plurality of inquiries, and generating the LLM agent asset are based at least in part on the one or more LLM agent asset parameters.

Aspect 8: The method of any of aspects 1 through 7, wherein the request comprise an indication of a purpose of the LLM agent asset and an indication of data to be associated with the LLM agent asset.

Aspect 9: The method of any of aspects 1 through 8, further comprising: receiving an indication of metadata associated with a processing environment associated with the client; wherein generating the LLM agent asset is based at least in part on processing the metadata with the LLM to produce one or more characteristics of the LLM agent asset.

Aspect 10: The method of any of aspects 1 through 9, wherein the LLM agent asset comprises a second LLM, an LLM prompt, or an LLM prompt template.

Aspect 11: The method of any of aspects 1 through 10, further comprising: receiving the request, the first plurality of inquiries, the second plurality of inquiries, or any combination thereof, via a group-based communication service, a web interface, a web portal, or any combination thereof.

Aspect 12: The method of any of aspects 1 through 11, wherein the request, the first plurality of responses, the second plurality of responses, or any combination thereof, comprise text input, audio input, or any combination thereof.

Aspect 13: An apparatus for large language model (LLM) agent asset generation, comprising one or more memories storing processor-executable code, and one or more processors coupled with the one or more memories and individually or collectively operable to execute the code to cause the apparatus to perform a method of any of aspects 1 through 12.

Aspect 14: An apparatus for large language model (LLM) agent asset generation, comprising at least one means for performing a method of any of aspects 1 through 12.

Aspect 15: A non-transitory computer-readable medium storing code for large language model (LLM) agent asset generation, the code comprising instructions executable by one or more processors to perform a method of any of aspects 1 through 12.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for large language model (LLM) agent asset generation, comprising:
receiving a request for generation, by an LLM, of an LLM agent asset for a client;
providing, based at least in part on the request, a first plurality of inquiries associated with one or more parameters of the LLM agent asset;
receiving a first plurality of responses to the first plurality of inquiries;
determining, via the LLM and based at least in part on the first plurality of responses, whether a second plurality of inquiries associated with one or more parameters of the LLM agent asset is to be provided to the client;
providing the second plurality of inquiries to the client, the second plurality of inquiries based at least in part on the first plurality of responses and the determination;
receiving a second plurality of responses in response to the second plurality of inquiries; and
generating the LLM agent asset based at least in part on the request, the first plurality of responses, and the second plurality of responses.

2. The method of claim 1, wherein generating the LLM agent asset comprises:
selecting, based at least in part on the request, the first plurality of responses, the second plurality of responses, or any combination thereof, one or more topics to be associated with the LLM agent asset, each topic being associated with a topic name, a classification description, a plurality of permitted operations that are associated with a cloud platform associated with the client, a plurality of prompt instructions, or any combination thereof; and
associating the selected one or more topics with the LLM agent asset.

3. The method of claim 2, wherein generating the LLM agent asset comprises:
selecting, based at least in part on the request, the first plurality of responses, the second plurality of responses, or any combination thereof, the plurality of permitted operations from a plurality of operations available to the LLM agent asset; and
associating the selected one or more operations with the LLM agent asset.

4. The method of claim 1, wherein generating the LLM agent asset comprises embedding information selected from at least the first plurality of responses, the second plurality of responses, or both, into one or more prompts associated with the LLM agent asset.

5. The method of claim 1, wherein determining whether the second plurality of inquiries is to be provided to the client comprises:
providing a prompt to the LLM, comprising a first instruction to analyze the first plurality of responses and the request to determine whether the LLM agent asset can be generated with information included in the first plurality of responses and the request; and
receiving an analysis response indicating that the second plurality of inquiries is to be provided to the client.

6. The method of claim 1, further comprising:
providing an orientation prompt to the LLM, the orientation prompt comprising instructions for the LLM to provide the first plurality of inquiries, determine whether the second plurality of inquiries is to be provided to the client, provide the second plurality of inquiries to the client, and generate the LLM agent asset.

7. The method of claim 1, further comprising:
receiving a natural language description of one or more characteristics of the LLM agent asset; and
interpreting, with the LLM, the natural language description to produce an indication of one or more LLM agent asset parameters corresponding with the one or more characteristics of the LLM agent asset;
wherein providing the first plurality of inquiries, providing the second plurality of inquiries, and generating the LLM agent asset are based at least in part on the one or more LLM agent asset parameters.

8. The method of claim 1, wherein the request comprise an indication of a purpose of the LLM agent asset and an indication of data to be associated with the LLM agent asset.

9. The method of claim 1, further comprising:
receiving an indication of metadata associated with a processing environment associated with the client;
wherein generating the LLM agent asset is based at least in part on processing the metadata with the LLM to produce one or more characteristics of the LLM agent asset.

10. The method of claim 1, wherein the LLM agent asset comprises a second LLM, an LLM prompt, or an LLM prompt template.

11. The method of claim 1, further comprising:
receiving the request, the first plurality of inquiries, the second plurality of inquiries, or any combination thereof, via a group-based communication service, a web interface, a web portal, or any combination thereof.

12. The method of claim 1, wherein the request, the first plurality of responses, the second plurality of responses, or any combination thereof, comprise text input, audio input, or any combination thereof.

13. An apparatus for large language model (LLM) agent asset generation, comprising:
one or more memories storing processor-executable code; and
one or more processors coupled with the one or more memories and individually or collectively operable to execute the code to cause the apparatus to:
receive a request for generation, by an LLM, of an LLM agent asset for a client;
provide, based at least in part on the request, a first plurality of inquiries associated with one or more parameters of the LLM agent asset;
receive a first plurality of responses to the first plurality of inquiries;
determine, via the LLM and based at least in part on the first plurality of responses, whether a second plurality of inquiries associated with one or more parameters of the LLM agent asset is to be provided to the client;
provide the second plurality of inquiries to the client, the second plurality of inquiries based at least in part on the first plurality of responses and the determination;
receive a second plurality of responses in response to the second plurality of inquiries; and
generate the LLM agent asset based at least in part on the request, the first plurality of responses, and the second plurality of responses.

14. The apparatus of claim 13, wherein, to generate the LLM agent asset, the one or more processors are individually or collectively operable to execute the code to cause the apparatus to:
select, based at least in part on the request, the first plurality of responses, the second plurality of responses, or any combination thereof, one or more topics to be associated with the LLM agent asset, each topic being associated with a topic name, a classification description, a plurality of permitted operations that are associated with a cloud platform associated with the client, a plurality of prompt instructions, or any combination thereof; and
associate the selected one or more topics with the LLM agent asset.

15. The apparatus of claim 14, wherein, to generate the LLM agent asset, the one or more processors are individually or collectively operable to execute the code to cause the apparatus to:
select, based at least in part on the request, the first plurality of responses, the second plurality of responses, or any combination thereof, the plurality of permitted operations from a plurality of operations available to the LLM agent asset; and
associate the selected one or more operations with the LLM agent asset.

16. The apparatus of claim 13, wherein generating the LLM agent asset comprises embedding information selected from at least the first plurality of responses, the second plurality of responses, or both, into one or more prompts associated with the LLM agent asset.

17. The apparatus of claim 13, wherein, to determine whether the second plurality of inquiries is to be provided to the client, the one or more processors are individually or collectively operable to execute the code to cause the apparatus to:
provide a prompt to the LLM, comprising a first instruction to analyze the first plurality of responses and the request to determine whether the LLM agent asset can be generated with information included in the first plurality of responses and the request; and
receive an analysis response indicating that the second plurality of inquiries is to be provided to the client.

18. The apparatus of claim 13, wherein the one or more processors are individually or collectively further operable to execute the code to cause the apparatus to:
provide an orientation prompt to the LLM, the orientation prompt comprising instructions for the LLM to provide the first plurality of inquiries, determine whether the second plurality of inquiries is to be provided to the client, provide the second plurality of inquiries to the client, and generate the LLM agent asset.

19. The apparatus of claim 13, wherein the one or more processors are individually or collectively further operable to execute the code to cause the apparatus to:
receive a natural language description of one or more characteristics of the LLM agent asset; and
interpret, with the LLM, the natural language description to produce an indication of one or more LLM agent asset parameters corresponding with the one or more characteristics of the LLM agent asset;
wherein providing the first plurality of inquiries, providing the second plurality of inquiries, and generating the LLM agent asset are based at least in part on the one or more LLM agent asset parameters.

20. A non-transitory computer-readable medium storing code for large language model (LLM) agent asset generation, the code comprising instructions executable by one or more processors to:
receive a request for generation, by an LLM, of an LLM agent asset for a client;
providing, based at least in part on the request, a first plurality of inquiries associated with one or more parameters of the LLM agent asset;
receive a first plurality of responses to the first plurality of inquiries;
determine, via the LLM and based at least in part on the first plurality of responses, whether a second plurality of inquiries associated with one or more parameters of the LLM agent asset is to be provided to the client;
provide the second plurality of inquiries to the client, the second plurality of inquiries based at least in part on the first plurality of responses and the determination;
receive a second plurality of responses in response to the second plurality of inquiries; and
generate the LLM agent asset based at least in part on the request, the first plurality of responses, and the second plurality of responses.
